(19) United States
(12) Patent Application Publication
(10) Pub. No.: US 2019/0166024 A1
(43) Pub. Date: May 30, 2019

(54) NETWORK ANOMALY ANALYSIS APPARATUS, METHOD, AND NON-TRANSITORY COMPUTER READABLE STORAGE MEDIUM THEREOF

(71) Applicant: Institute For Information Industry, Taipei (TW)

(72) Inventors: Chih-Hsiang Ho, Taipei City (TW); Li-Sheng Chen, Yilan County (TW); Wei-Ho Chung, Taipei City (TW); Sy-Yen Kuo, Taipei City (TW)

(21) Appl. No.: 15/822,022

(22) Filed: Nov. 24, 2017

(51) Int. Cl. H04L 12/26; G06N 99/00

(52) U.S. Cl. CPC H04L 43/0823; G06N 99/005

(57) ABSTRACT

A network anomaly analysis apparatus, method, and non-transitory computer readable storage medium thereof are provided. The network anomaly analysis apparatus stores a plurality of network status data and is configured to dimension-reduce each network status datum into a principal component datum, select a first subset and a second subset of the principal component data as the training data and the testing data respectively, derive a classification model by classifying the training data into a plurality of normal data and a plurality of abnormal data, derive a clustering model by clustering the abnormal data, derive an accuracy rate by testing the classification model and the clustering model by the testing data, select a third subset of the principal component data as a plurality of validation data when the accuracy rate fails to reach a threshold, and update the classification model and the clustering model with the validation data.

### FIELD

The present invention relates to a network anomaly analysis apparatus, method, and a non-transitory computer readable storage medium thereof. More particularly, the present invention relates to a network anomaly analysis apparatus, method, and non-transitory computer readable storage medium thereof that are related to machine learning.

### BACKGROUND

With the rapid development of the science and technology, numerous networks constructed by different communication technologies are now available. A network may operate abnormally due to many factors, such as interference between base stations, errors in a media access control (MAC) layer, errors in a physical layer, etc.

Although some technologies detecting abnormal statuses of networks by using machine learning models are available in the prior art, these technologies all have disadvantages. For example, in some technologies of the prior art requires a professional in a communication company to determines which network parameters in one network environment are more important based on his/her experience and then uses these network parameters to train a machine learning model for detecting a network abnormal status. However, different network environments will be influenced by different factors, so the determination result made by the professional for a certain network environment is often unsuitable for another network environment. Additionally, some technologies in the prior art perform analysis only for some application program(s) in a network environment and not for the whole network environment, so the model obtained through training is unsuitable for other application programs of the network environment.

Accordingly, an urgent need exists in the art to provide a technology which is capable of objectively selecting more important network parameters in a network environment for detecting and analyzing network anomalies.

### SUMMARY

The disclosure includes a network anomaly analysis apparatus. The network anomaly analysis apparatus in one example embodiment comprises a storage unit and a processor electrically connected to the storage unit. The storage unit stores a plurality of network status data, wherein each of the network status data comprises a plurality of network feature values. The processor is configured to dimension-reduce each of the network status data into a principal component datum by analyzing the network feature values comprised in the network status data according to a dimension-reduce algorithm, select a first subset of the principal component data as a plurality of training data, derive a classification model by classifying the training data into a plurality of first normal data and a plurality of first abnormal data according to a classification algorithm, and derive a clustering model by clustering the first abnormal data into a plurality of first abnormal groups according to a clustering algorithm.

The processor can also be configured to select a second subset of the principal component data as a plurality of testing data, derive an accuracy rate by testing the classification model and the clustering model by the testing data, determine that the accuracy rate fails to reach a threshold, select a third subset of the principal component data as a plurality of validation data after determining that the accuracy rate fails to reach the threshold, update the classification model by classifying the validation data into a plurality of second normal data and a plurality of second abnormal data according to the classification algorithm, update the clustering model by clustering the second abnormal data into a plurality of second abnormal groups according to the clustering algorithm, and output the updated classification model and the updated clustering model.

The disclosure also includes a network anomaly analysis method, which is adapted for an electronic computing apparatus. The electronic computing apparatus in one example embodiment stores a plurality of network status data, wherein each of the network status data comprises a plurality of network feature values. The network anomaly analysis method comprises the following steps of: (a) dimension-reducing each of the network status data into a principal component datum by analyzing the network feature values comprised in the network status data according to a dimension-reduce algorithm, (b) selecting a first subset of the principal component data as a plurality of training data, (c) deriving a classification model by classifying the training data into a plurality of first normal data and a plurality of first abnormal data according to a classification algorithm, (d) deriving a clustering model by clustering the first abnormal data into a plurality of first abnormal groups according to a clustering algorithm, (e) selecting a second subset of the principal component data as a plurality of testing data, (f) deriving an accuracy rate by testing the classification model and the clustering model by the testing data, (g) determining that the accuracy rate fails to reach a threshold, (h) selecting a third subset of the principal component data as a plurality of validation data after determining that the accuracy rate fails to reach the threshold, (i) updating the classification model by classifying the validation data into a plurality of second normal data and a plurality of second abnormal data according to the classification algorithm, (j) updating the clustering model by clustering the second abnormal data into a plurality of second abnormal groups according to the clustering algorithm, and (k) outputting the updated classification model and the updated clustering model.

The disclosure further includes a non-transitory computer readable storage medium, which has a computer program stored therein. After the computer program is loaded into an electronic computing apparatus, the electronic computing apparatus executes the codes of the computer program to perform the network anomaly analysis method described in the above paragraph.

The network anomaly analysis technology (including the apparatus, method, and the non-transitory computer readable storage medium thereof) disclosed herein adopt techniques related to machine learning to train the classification model and the clustering model that are used for detecting the network anomaly. Generally speaking, the network anomaly analysis technology provided by the present invention analyzes the network feature values comprised in the collected network status data according to the dimension-reduce algorithm so as to dimension-reduce the network status data into principal component data (i.e., excludes network feature values of less importance in the network status data), and takes a first subset, a second subset, and a third subset of the principal component data as the training data, the testing data, and the validation data respectively. The training data is used for the subsequent classification training and clustering training, the testing data is used for determining whether results of the classification training and clustering training reach a preset standard, and the validation data is used for performing the classification training and clustering training again if the results of the classifying training and/or the clustering training fail to reach the preset standard.

Since the operations of the network anomaly analysis technology provided by the present invention starts from analyzing the network feature values comprised in all the collected network status data, it is suitable for various network environments. Moreover, the network anomaly analysis technology provided by the present invention trains the classification model and the clustering model by the principal component data that have been dimension-reduced, so the overfitting phenomenon caused by less important network feature values in the training process can be eliminated. Thereby, the accuracy rate regarding classifying and clustering network anomaly can be increased and the result of detecting network anomaly becomes more accurate. Additionally, since the network anomaly analysis technology provided by the present invention updates the classification model and the clustering model by the validation data, more accurate classification model and clustering model can be provided to detect the network anomaly. This helps a network administrator and/or a user learn the reason of the network anomaly and then solve the problem.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting an architecture of a network anomaly analysis apparatus 1 according to a first embodiment;

FIG. 2 depicts a specific example of selecting a third subset by using a distance from each of principal component data to a classification model; and

FIG. 3 is a flowchart diagram depicting a network anomaly analysis method according to a second embodiment.

### DETAILED DESCRIPTION

In the following description, a network anomaly analysis apparatus, method, and non-transitory computer readable storage medium thereof will be explained with reference to example embodiments thereof. However, these example embodiments are not intended to limit the present invention to any specific embodiment, example, environment, applications, or implementations described in these example embodiments. Therefore, description of these example embodiments is only for purpose of illustration rather than to limit the scope of the present invention.

It shall be appreciated that, in the following embodiments and the attached drawings, elements unrelated to the present invention are omitted from depiction. In addition, dimensions of elements and dimensional relationships among individual elements in the attached drawings are only for the purpose of illustration, but not to limit the scope of the present invention.

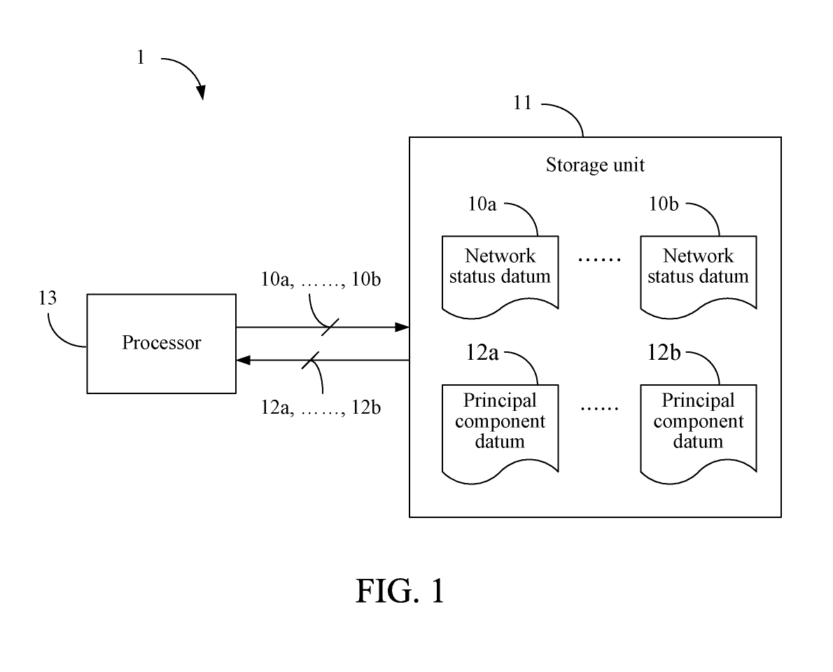

A first embodiment of the present invention is a network anomaly analysis apparatus 1, wherein a schematic view of which is depicted in FIG. 1. The network anomaly analysis apparatus 1 comprises a storage unit 11 and a processor 13 electrically connected to the storage unit 11. The storage unit 11 may be a memory, a universal serial bus (USB) disk, a hard disk, a compact disk (CD), a mobile disk, a database, or any other storage medium or circuit with the same function and well known to those of ordinary skill in the art. The processor 13 may be any of various processors, central processing units (CPUs), microprocessors, or other computing devices well known to those of ordinary skill in the art. The network anomaly analysis apparatus 1 may be implemented as a server at the back end of a network (e.g., a machine type communication (MTC) server in a Long Term Evolution (LTE) standard), a cloud server, a base station, or other apparatuses having similar or greater computation capability.

The storage unit 11 stores a plurality of network status data 10a, . . . , 10b collected from various nodes (e.g., a base station, a mobile apparatus, a gateway, etc.) in one or more network environments. Each of the network status data 10a, . . . , 10b comprises a plurality of network feature values (e.g., the number of network feature values is D, wherein D is a positive integer), wherein each of the network feature values comprised in each of the network status data 10a, . . . , 10b is associated with a network parameter (e.g., a communication quality). For example, the network parameter may be a signal strength, a Reference Signal Received Power (RSRP), a Reference Signal Received Quality (RSRQ), a Bit Error Rate (BER), a Packet Error Rate (PER), a data rate, or the like. In order to derive more accurate classification model and clustering model in the subsequent training procedure, each of the network feature values comprised in each of the network status data 10a, . . . , 10b may be a datum obtained by normalizing a value of a network parameter.

In this embodiment, the processor 13 analyzes the network feature values comprised in the network status data 10a, . . . , 10b (e.g., analyzes correlations, interdependency, and/or particularity among the network feature values) according to a dimension-reduce algorithm (e.g., a high correlation filter, a random forests algorithm, a forward feature construction algorithm, a backward feature elimination algorithm, a missing values ratio algorithm, a low variance filter algorithm, and a principal component analysis algorithm, but not limited thereto) so as to dimension-reduce the network status data 10a, . . . , 10b into a plurality of principal component data 12a, . . . , 12b (e.g., reduce to K dimensions from D dimensions, wherein K is a positive integer smaller than D). The objective of processing the network status data 10a, . . . , 10b according to the dimension-reduce algorithm is to find out network feature values which are more representative and crucial from the network status data 10a, . . . , 10b for later use of training models, thereby avoiding the overfitting phenomenon caused by training the models with all the network feature values, and improving the accuracy rate of machine learning.

For ease of understanding, the process of dimension-reduction is described herein with a specific example. However, this specific example is not intended to limit the scope of the present invention. Here, it is assumed that the dimension-reduce algorithm used by the processor 13 is the principal component analysis method. As described above, each of the network status data 10a, . . . , 10b is D-dimensional, and the network feature values comprised in each of the network status data 10a, . . . , 10b are normalized data. The processor 13 creates a covariance matrix according to the network status data 10a, . . . , 10b, decomposes the covariance matrix into eigenvectors and eigenvalues, and selects K (it shall be appreciated that K is a positive integer smaller than D and represents the dimension after the dimension-reduction) eigenvectors corresponding to K largest eigenvalues. Next, the processor 13 sorts the K eigenvectors being selected and creates a projection matrix according to the K eigenvectors being sorted. Thereafter, the processor 13 derives the principal component data 12a, . . . , 12b by applying the projection matrix to the network status data 10a, . . . , 10b (e.g., if the D-dimensional network status data 10a, . . . , 10b are represented as a matrix, the K-dimensional principal component data 12a, . . . , 12b can be obtained by matrix multiplication).

Next, the processor 13 selects a first subset of the principal component data 12a, . . . , 12b as a plurality of training data. Please note that the way that the processor 13 selects the first subset serving as the training data (i.e., the way for selecting the training data) is not limited by the present invention. For example, the processor 13 may randomly select some of the principal component data 12a, . . . , 12b as the aforesaid training data. As another example, the processor 13 may select the training data from the principal component data 12a, . . . , 12b according to normal distribution.

After selecting the training data, the processor 13 classifies the training data 10b into a plurality of first normal data and a plurality of first abnormal data according to a classification algorithm (e.g., a support vector machine, a linear classification algorithm, and a K-nearest neighbor algorithm, but not limited thereto) and, thereby, a classification model is derived. For example, after classifying the training data into the first normal data and the first abnormal data according to the classification algorithm, the processor 13 can ascertain a function for classifying the first normal data and the first abnormal data. The function is the classification model ascertained through training.

Next, the processor 13 derives a clustering model by clustering the first abnormal data into a plurality of first abnormal groups according to a clustering algorithm (e.g., a K-means algorithm, an agglomerative clustering algorithm and a divisive clustering algorithm, but not limited thereto). For example, after clustering the first abnormal data into the first abnormal groups, the processor 13 can ascertain one or more functions for clustering the first abnormal groups. The aforementioned one or more functions are the clustering model ascertained through training.

Then, the network anomaly analysis apparatus 1 tests the accuracy of the classification model and the clustering model. If an accuracy rate of the classification model and the clustering model fails to reach a threshold, the network anomaly analysis apparatus 1 re-trains the classification model and the clustering model.

Specifically, the processor 13 selects a second subset of the principal component data 12a, . . . , 12b as a plurality of testing data. Please note that the way that the processor 13 selects the second subset serving as the testing data is not limited by the present invention. In addition, the selection of the testing data will not be influenced by the selection of the first subset. For example, the processor 13 may randomly select some of the principal component data 12a, . . . , 12b as the aforesaid testing data. As another example, the processor 13 may select the aforesaid testing data from the principal component data 12a, . . . , 12b according to normal distribution.

Next, the processor 13 derives an accuracy rate by testing the classification model and the clustering model by the testing data. How to derive an accuracy rate by testing the classification model and the clustering model according to the testing data shall be appreciated by those of ordinary skill in the art and, thus, the details will not be further described herein. The processor 13 determines whether the accuracy rate reaches a threshold. If the accuracy rate reaches the threshold, the processor 13 outputs the classification model and the clustering model for subsequent network anomaly detection. If the accuracy rate fails to reach the threshold, the processor 13 re-trains the classification model and the clustering model. Specifically, the processor 13 selects a third subset of the principal component data 12a, . . . , 12b as a plurality of validation data, updates the classification model by classifying the validation data into a plurality of second normal data and a plurality of second abnormal data according to the classification algorithm, and updates the clustering model by clustering the second abnormal data into a plurality of second abnormal groups according to the clustering algorithm. Thereafter, the processor 13 can output the updated classification model and the updated clustering model. It shall be appreciated that, in some embodiments, the processor 13 may repeat the aforesaid operations until the accuracy rates of the updated classification model and the updated clustering model reach the threshold.

The details regarding how the processor 13 selects the third subset from the principal component data 12a, . . . , 12b will be described herein.

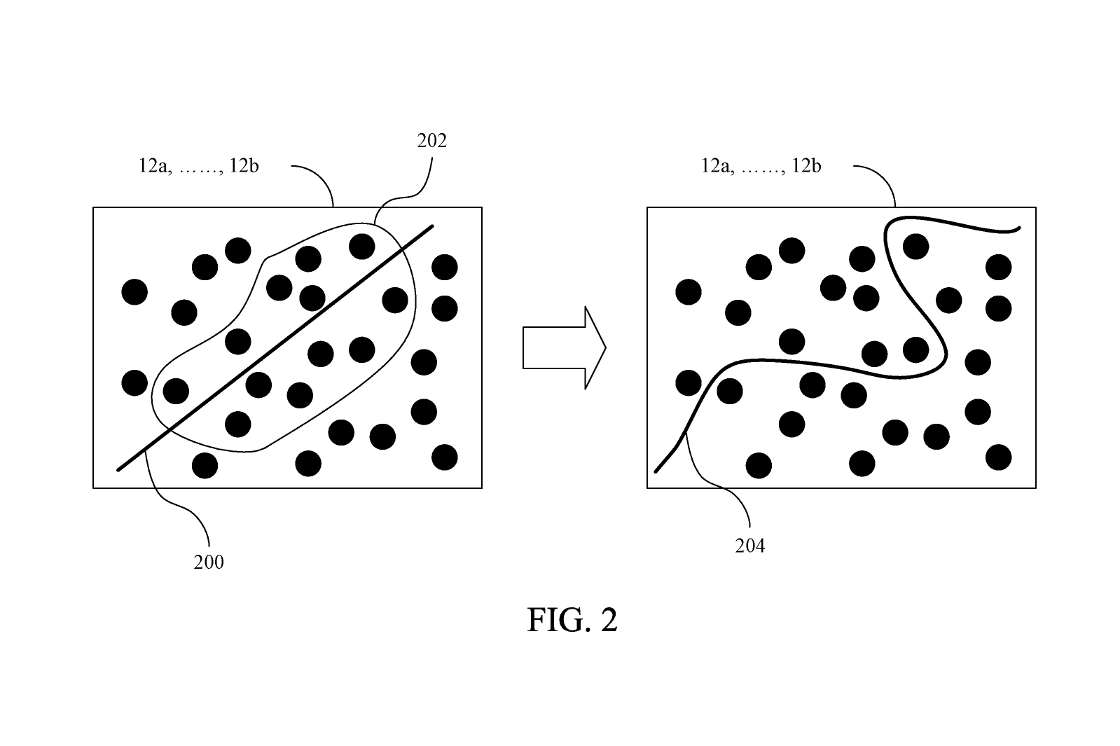

In some embodiments, the processor 13 may select the third subset (i.e., select the validation data) according to a distance from each of the principal component data 12a, . . . , 12b to the classification model. Please refer to a specific example depicted in FIG. 2 for ease of understanding, which, however, is not intended to limit the scope of the present invention. The drawing at the left side of FIG. 2 is a schematic view depicting the principal component data 12a, . . . , 12b (each black dot represents a principal component datum) and a classification model 200 obtained through training. The processor 13 calculates the distance (e.g., a Euclidean distance) from each of the principal component data 12a, . . . , 12b to the classification model 200 and selects the principal component data whose distance is smaller than a second threshold as validation data 202. The drawing at the right side of FIG. 2 depicts a classification model 204 that is updated by the validation data 202. The logic of deciding the validation data 202 in this manner lies in that the network feature values of the principal component data whose distance to the classification model 200 is smaller are more ambiguous to the classification model 200. Therefore, if the new classification model 204 is decided by the principal component data having smaller distance to the classification model 200, the new classification model 204 can classify the principal component data having smaller distance to the classification model 200 more precisely.

In some embodiments, the processor 13 may select the third set (i.e., select the validation data) according to time information of each of the principal component data 12a, . . . , 12b. Specifically, each of the principal component data 12a, . . . , 12b has a piece of time information (e.g., the time when the corresponding network status data 10a, . . . , 10b are retrieved/collected), and the processor 13 divides the principal component data 12a, . . . , 12b into a plurality of groups according to the pieces of time information (e.g., divides the time range covered by the principal component data 12a, . . . , 12b into non-overlapped time intervals, and divides the principal component data 12a, . . . , 12b into a plurality of groups according to the time intervals). Then, the processor 13 selects at least one principal component datum from each of the groups as the validation data. The purpose of selecting the validation data in this manner is to break the dependency of time and, therefore, the processor 13 can consider the influence of time to the network environment when updating the classification model.

In some embodiments, the processor 13 may select the third subset (i.e., select the validation data) according to regional information of each of the principal component data 12a, . . . , 12b. Specifically, each of the principal component data 12a, . . . , 12b has a piece of regional information (e.g., the Internet address, an address of a base station that the principal component datum belongs), and the processor 13 divides the principal component data 12a, . . . , 12b into a plurality of groups according to the pieces of regional information (e.g., divides the principal component data 12a, . . . , 12b into a plurality of non-overlapped groups depending on the addresses of the base stations to which the principal component data belong). The processor 13 then selects at least one principal component datum from each of the groups as the validation data. The purpose of deciding the validation data in this manner is to break the dependency of regions, and, therefore, the processor 13 can consider the influence of regional information to the network environment when updating the classification model.

As can be known from the above descriptions, the operation of the network anomaly analysis apparatus 1 starts from analyzing the network feature values comprised in all the collected network status data, so the trained classification model and the clustering model are suitable for various network environments. Therefore, the problem that the network parameters need to be determined by professionals and are limited to particular network environments of the prior art are solved. Moreover, the network anomaly analysis apparatus 1 dimension-reduces the network status data 10a, . . . , 10b into principal component data 12a, . . . , 12b according to a dimension-reduce algorithm, thereby selecting more important network feature values for training models. In this way, the network anomaly analysis apparatus 1 eliminates the overfitting problem caused by less important network feature values in the training process, thereby improving the accuracy rate of the classification model and the clustering model obtained through training and providing more accurate network anomaly detection results.

Additionally, the network anomaly analysis apparatus 1 further updates the classification model and the clustering model by the validation data when the accuracy rate of the classification model and the clustering model fails to reach the threshold. As a result, more accurate classification model and clustering model can be provided to detect the network anomaly and determine the category of the network anomaly. This helps the network administrator and/or the user learn the reason of the network anomaly and then solve the problem.

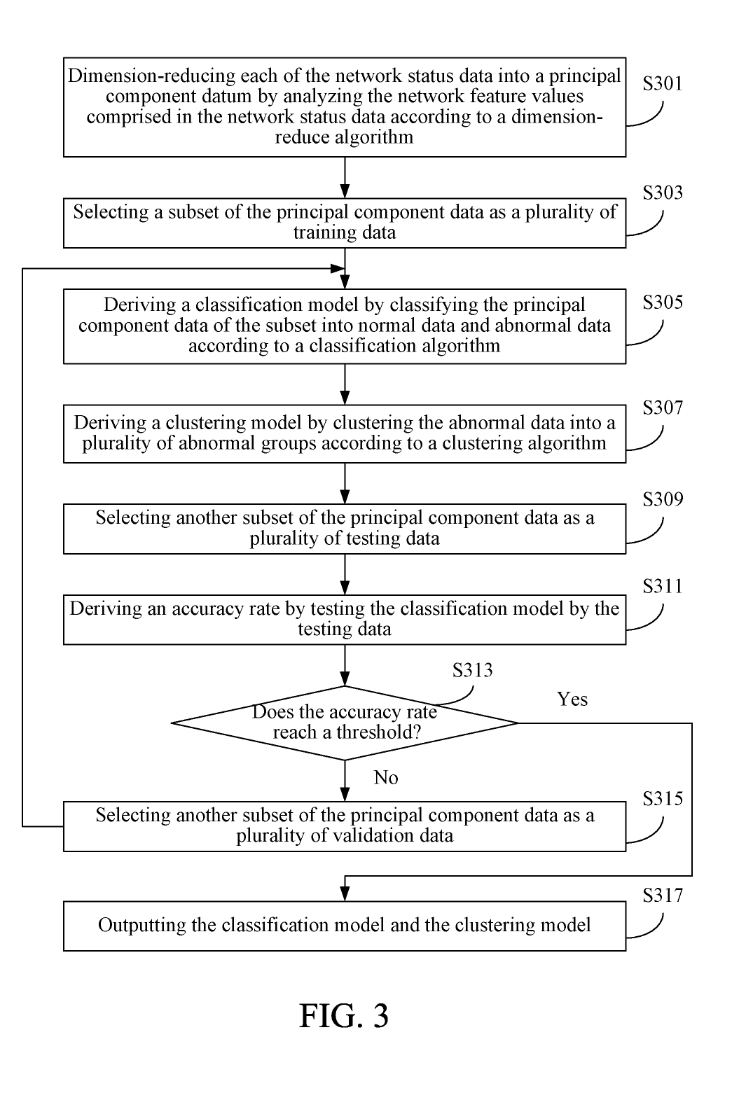

A second embodiment of the present invention is a network anomaly analysis method, and a flowchart diagram thereof is depicted in FIG. 3. The network anomaly analysis method is adapted for an electronic computing apparatus (e.g., the network anomaly analysis apparatus 1 of the first embodiment). In this embodiment, the electronic computing apparatus stores a plurality of network status data, wherein each of the network status data comprises a plurality of network feature values.

In step S301, the electronic computing apparatus dimension-reduces each of the network status data into a principal component datum by analyzing the network feature values comprised in the network status data according to a dimension-reduce algorithm. For example, the dimension-reduce algorithm adopted in the step S301 may be a high correlation filter, a random forests algorithm, a forward feature construction algorithm, a backward feature elimination algorithm, a missing values ratio algorithm, a low variance filter algorithm, or a principal component analysis algorithm, but it is not limited thereto.

Then, in step S303, the electronic computing apparatus selects a subset of the principal component data as a plurality of training data. In step S305, the electronic computing apparatus derives a classification model by classifying the principal component data comprised in the subset into a plurality of normal data and a plurality of abnormal data according to a classification algorithm. For example, the classification algorithm adopted in the step S305 may be a support vector machine, a linear classification algorithm and a K-nearest neighbor algorithm, but it is not limited thereto. It shall be appreciated that, when the step S305 is executed for the first time, the principal component data comprised in the subset is the training data selected in the step S303. When the step S305 is not executed for the first time, the principal component data comprised in the subset is the validation data selected in step S315 (which will be described later).

In step S307, the electronic computing apparatus derives a clustering model by clustering the abnormal data into a plurality of abnormal groups according to a clustering algorithm. For example, the clustering algorithm adopted in the step S307 may be a K-means algorithm, an agglomerative clustering algorithm or a divisive clustering algorithm, but it is not limited thereto. It shall be appreciated that, in some embodiments, step S317 may be directly executed to output the classification model and the clustering model by the electronic computing apparatus after the step S307 is executed.

In this embodiment, after the step S307 is executed, step S309 is executed by the electronic computing apparatus to select another subset of the principal component data as a plurality of testing data. Next, step S311 is executed by the electronic computing apparatus to derive an accuracy rate through testing the classification model with the testing data. Thereafter, in step S313, the electronic computing apparatus determines whether the accuracy rate reaches a threshold.

If the determination result of the step S313 is yes, the step S317 is executed by the electronic computing apparatus to output the classification model and the clustering model. If the determination result of the step S313 is no, the classification model and the clustering model are refined. Specifically, in step S315, the electronic computing apparatus selects another subset of the principal component data as a plurality of validation data. Then, the steps S303 to S313 are executed again. The network anomaly analysis method repeats the aforesaid steps until the determination result of the step S313 is that the accuracy rate reaches the threshold. Then, the step S317 is executed to output the classification model and the clustering model.

It shall be appreciated that, in some embodiments, the step S315 calculates a distance from each of the principal component data to the classification model and selects the principal component data whose distance is smaller than another threshold as the validation data when selecting a subset of the principal component data as the plurality of validation data.

Additionally, in some embodiments, the step S315 uses time information of each of the principal component data when selecting a subset of the principal component data as the plurality of validation data. Specifically, the step S315 may divide the principal component data into a plurality of groups according to the time information, and then select at least one principal component datum from each of the groups as the validation data.

Moreover, in some embodiments, the step S315 uses regional information of each of the principal component data when selecting a subset of the principal component data as the plurality of validation data. Specifically, the step S315 may divide the principal component data into a plurality of groups according to the regional information, and then select at least one principal component datum from each of the groups as the validation data.

In addition to the aforesaid steps, the second embodiment can also execute all the operations and steps set forth in the first embodiment, have the same functions, and deliver the same technical effects as the first embodiment. How the second embodiment executes these operations and steps, has the same functions, and delivers the same technical effects as the first embodiment will be readily appreciated by those of ordinary skill in the art based on the explanation of the first embodiment, and thus will not be further described herein.

The network anomaly analysis method described in the second embodiment may be implemented by a computer program comprising a plurality of codes. The computer program is stored in a non-transitory computer readable storage medium. When the computer program loaded into an electronic computing apparatus (e.g., the network anomaly analysis apparatus 1), the computer program executes the network anomaly analysis method as described in the second embodiment. The non-transitory computer readable storage medium may be an electronic product, e.g., a read only memory (ROM), a flash memory, a floppy disk, a hard disk, a compact disk (CD), a mobile disk, a database accessible to networks, or any other storage media with the same function and well known to those of ordinary skill in the art.

It shall be appreciated that, in the specification of the present invention, terms “first,” “second,” and “third” used in the first subset, the second subset, and the third subset are only used to mean that these subsets are different subsets. The terms “first” and “second” used in the first normal data and the second normal data are only used to mean that these normal data are normal data obtained in different times of classifying operations. The terms “first” and “second” used in the first abnormal data and the second abnormal data are only used to mean that these abnormal data are abnormal data obtained in different times of classifying operations. The terms “first” and “second” used in the first abnormal group and the second abnormal group are only used to mean that these abnormal groups are abnormal groups obtained in different times of clustering operations.

According to the above descriptions, the network anomaly analysis technology (including the apparatus, method, and the non-transitory computer readable storage medium thereof) provided by the present invention dimension-reduces the collected network status data to obtain more representative principal component data (i.e., excludes network feature values of less importance in the network status data), selects a subset of the principal component data as the training data, generates a classification model and a clustering model according to a classification algorithm and a clustering algorithm respectively, and then tests the accuracy rate of the classification model and the clustering model with another subset of the principal component data. If the accuracy rate fails to reach a preset value, the network anomaly analysis technology provided by the present invention selects another subset of the principal component data to refine the classification model and the clustering model, wherein the another subset is selected by taking other factors (e.g., the time factor, the regional factor, or the distance to the classification model) into consideration.

The classification model and the clustering model trained by the network anomaly analysis technology according to the present invention are suitable for various network environments and, thereby, solves the problem that the network parameters need to be determined by professionals and are limited to particular network environments in the prior art. Moreover, the network anomaly analysis technology of the present invention eliminates the overfitting problem caused by less important network feature values in the training process and, thereby, improves the accuracy of the trained classification model and the clustering model and provides more accurate network anomaly detection results.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network anomaly analysis apparatus, comprising:
a storage unit, being configured to store a plurality of network status data, wherein each of the network status data comprises a plurality of network feature values; and
a processor, being electrically connected to the storage unit and configured to dimension-reduce each of the network status data into a principal component datum by analyzing the network feature values comprised in the network status data according to a dimension-reduce algorithm, select a first subset of the principal component data as a plurality of training data, derive a classification model by classifying the training data into a plurality of first normal data and a plurality of first abnormal data according to a classification algorithm, and derive a clustering model by clustering the first abnormal data into a plurality of first abnormal groups according to a clustering algorithm;
wherein the processor selects a second subset of the principal component data as a plurality of testing data, derives an accuracy rate by testing the classification model and the clustering model by the testing data, determines that the accuracy rate fails to reach a first threshold, selects a third subset of the principal component data as a plurality of validation data after determining that the accuracy rate fails to reach the first threshold, updates the classification model by classifying the validation data into a plurality of second normal data and a plurality of second abnormal data according to the classification algorithm, updates the clustering model by clustering the second abnormal data into a plurality of second abnormal groups according to the clustering algorithm, and outputs the updated classification model and the updated clustering model.

2. The network anomaly analysis apparatus of claim 1, wherein the processor calculates a distance from each of the principal component data to the classification model and selects the principal component data whose distance is smaller than a second threshold as the validation data.

3. The network anomaly analysis apparatus of claim 1, wherein each of the principal component data has a piece of time information, the processor divides the principal component data into a plurality of groups according to the pieces of time information, and wherein the processor selects at least one principal component datum from each of the groups as the validation data.

4. The network anomaly analysis apparatus of claim 1, wherein each of the principal component data has a piece of regional information, the processor divides the principal component data into a plurality of groups according to the pieces of regional information, and wherein the processor selects at least one principal component datum from each of the groups as the validation data.

5. The network anomaly analysis apparatus of claim 1, wherein the dimension-reduce algorithm is one of a high correlation filter, a random forests algorithm, a forward feature construction algorithm, a backward feature elimination algorithm, a missing values ratio algorithm, a low variance filter algorithm, and a principal component analysis algorithm.

6. The network anomaly analysis apparatus of claim 1, wherein the classification algorithm is one of a support vector machine, a linear classification algorithm and a K-nearest neighbor algorithm.

7. The network anomaly analysis apparatus of claim 1, wherein the clustering algorithm is one of a K-means algorithm, an agglomerative clustering algorithm and a divisive clustering algorithm.

8. A network anomaly analysis method, being adapted for an electronic computing apparatus, the electronic computing apparatus storing a plurality of network status data, each of the network status data comprising a plurality of network feature values, the network anomaly analysis method comprising:
dimension-reducing each of the network status data into a principal component datum by analyzing the network feature values comprised in the network status data according to a dimension-reduce algorithm;
selecting a first subset of the principal component data as a plurality of training data;
deriving a classification model by classifying the training data into a plurality of first normal data and a plurality of first abnormal data according to a classification algorithm;
deriving a clustering model by clustering the first abnormal data into a plurality of first abnormal groups according to a clustering algorithm;
selecting a second subset of the principal component data as a plurality of testing data;
deriving an accuracy rate by testing the classification model and the clustering model by the testing data;
determining that the accuracy rate fails to reach a first threshold;
selecting a third subset of the principal component data as a plurality of validation data after determining that the accuracy rate fails to reach the first threshold;
updating the classification model by classifying the validation data into a plurality of second normal data and a plurality of second abnormal data according to the classification algorithm;
updating the clustering model by clustering the second abnormal data into a plurality of second abnormal groups according to the clustering algorithm; and
outputting the updated classification model and the updated clustering model.

9. The network anomaly analysis method of claim 8, further comprising:
calculating a distance from each of the principal component data to the classification model; and
selecting the principal component data whose distance is smaller than a second threshold as the validation data.

10. The network anomaly analysis method of claim 8, wherein each of the principal component data has a piece of time information, and the network anomaly analysis method further comprises:
dividing the principal component data into a plurality of groups according to the pieces of time information; and
selecting at least one principal component datum from each of the groups as the validation data.

11. The network anomaly analysis method of claim 8, wherein each of the principal component data has a piece of regional information, and the network anomaly analysis method further comprises:
dividing the principal component data into a plurality of groups according to the pieces of regional information; and
selecting at least one principal component datum from each of the groups as the validation data.

12. The network anomaly analysis method of claim 8, wherein the dimension-reduce algorithm is one of a high correlation filter, a random forests algorithm, a forward feature construction algorithm, a backward feature elimination algorithm, a missing values ratio algorithm, a low variance filter algorithm, and a principal component analysis algorithm.

13. The network anomaly analysis method of claim 8, wherein the classification algorithm is one of a support vector machine, a linear classification algorithm, and a K-nearest neighbor algorithm.

14. The network anomaly analysis method of claim 8, wherein the clustering algorithm is one of a K-means algorithm, an agglomerative clustering algorithm, and a divisive clustering algorithm.

15. A non-transitory computer readable storage medium, having a computer program stored therein, the computer program executing a network anomaly analysis method after being into an electronic computing apparatus, the electronic computing apparatus storing a plurality of network status data, each of the network status data comprising a plurality of network feature values, and the network anomaly analysis method comprising:
dimension-reducing each of the network status data into a principal component datum by analyzing the network feature values comprised in the network status data according to a dimension-reduce algorithm;
selecting a first subset of the principal component datum as a plurality of training data;
deriving a classification model by classifying the training data into a plurality of first normal data and a plurality of first abnormal data according to a classification algorithm;
deriving a clustering model by clustering the first abnormal data into a plurality of first abnormal groups according to a clustering algorithm;
selecting a second subset of the principal component data as a plurality of testing data;
deriving an accuracy rate by testing the classification model and the clustering model by the testing data;
determining that the accuracy rate fails to reach a threshold;
selecting a third subset of the principal component data as a plurality of validation data after determining that the accuracy rate fails to reach the threshold;
updating the classification model by classifying the validation data into a plurality of second normal data and a plurality of second abnormal data according to the classification algorithm;
updating the clustering model by clustering the second abnormal data into a plurality of second abnormal groups according to the clustering algorithm; and
outputting the updated classification model and the updated clustering model.
